(19) United States
(12) Patent Application Publication
(10) Pub. No.: US 2009/0167201 A1
(43) Pub. Date: Jul. 2, 2009

(54) LIGHT SOURCE AND METHODS FOR MICROSCOPY AND ENDOSCOPY

(75) Inventors: Markus Duelli, San Francisco, CA (US); Richard Gilliard, Morgan Hill, CA (US); Abdeslam Hafidi, Cupertino, CA (US); Gregg Hollingsworth, Tempe, AZ (US)

Correspondence Address: SCHWEGMAN, LUNDBERG & WOESSNER, P.A., P.O. BOX 2938, MINNEAPOLIS, MN, 55402, US

(73) Assignee: Luxim Corporation.

(21) Appl. No.: 12/266,743

(22) Filed: Nov. 7, 2008

Related U.S. Application Data
(60) Provisional application No. 60/986,263, filed on Nov. 7, 2007.

(51) Int. Cl. H05B 41/24

(52) U.S. Cl. 315/248

(57) ABSTRACT

In one example embodiment, a drive probe is coupled to the lamp body to provide the primary power for ignition and steady state operation of the lamp. Feedback may be used to adjust frequency in response to changing conditions of the lamp during startup. A phase shifter may be used to adjust the phase of the power between ignition and steady state operation. A sensor may detect a lamp operating condition that automatically triggers a shift in phase after the fill in the bulb is vaporized. In another example embodiment, a method for sequentially optimizing the drive power and phase shift applied to the lamp is disclosed that may reliably regulate the lamp current consumption to desired startup and operational levels despite variations in lamp environmental conditions.

### CROSS-REFERENCE TO RELATED APPLICATIONS

This application claims the benefit of provisional U.S. patent application Ser. No. 60/986,263, filed on Nov. 7, 2007, which is hereby incorporated by reference in its entirety.

### BACKGROUND

The field relates to systems and methods for generating light, and more particularly to electrodeless plasma lamps for medical and scientific applications such as microscopy and endoscopy.

### BRIEF DESCRIPTION OF THE DRAWINGS

FIG. 1A is a cross-section and schematic view of a plasma lamp according to an example embodiment.

FIG. 1B is a perspective cross section view of a lamp body with a cylindrical outer surface according to an example embodiment.

FIG. 1C is a perspective cross section view of a lamp body with a rectangular outer surface according to an alternative example embodiment.

FIG. 2A is a side cross section of a bulb according to an example embodiment.

FIG. 2B illustrates the resistance of a noble gas after breakdown at a pressure less than 200 Torr.

FIG. 2C illustrates the resistance of a noble gas after breakdown at a pressure of more than 400 Torr.

FIG. 2D is a chart showing the startup time for an example low pressure fill.

FIG. 2E is a chart showing the startup time for an example high pressure fill according to an example embodiment.

FIG. 2F is a chart showing the changes in startup time for example high pressure fills of 400 Torr and 600 Torr during a burn-in process.

FIG. 2G is a side cross section of a bulb with a tail according to an example embodiment.

FIG. 2H illustrates the spectrum produced by a fill according to an example embodiment.

FIG. 2I illustrates a lens system according to an example embodiment.

FIG. 3 is a flow chart of a method for starting an electrodeless plasma lamp with a Noble gas, Mercury and metal halide fill according to an example embodiment.

FIG. 4 is a block diagram of control electronics for an electrodeless plasma lamp according to an example embodiment.

FIG. 5A is a block diagram of an illumination and microscopy system according to an example embodiment.

FIG. 5B is a block diagram of an illumination and microscopy system according to another example embodiment.

FIG. 6 is a block diagram of an illumination and endoscopy system according to an example embodiment.

### DESCRIPTION

While the present invention is open to various modifications and alternative constructions, the embodiments shown in the drawings will be described herein in detail. It is to be understood, however, there is no intention to limit the invention to the particular forms disclosed. On the contrary, it is intended that the invention cover all modifications, equivalences and alternative constructions falling within the spirit and scope of the invention as expressed in the appended claims.

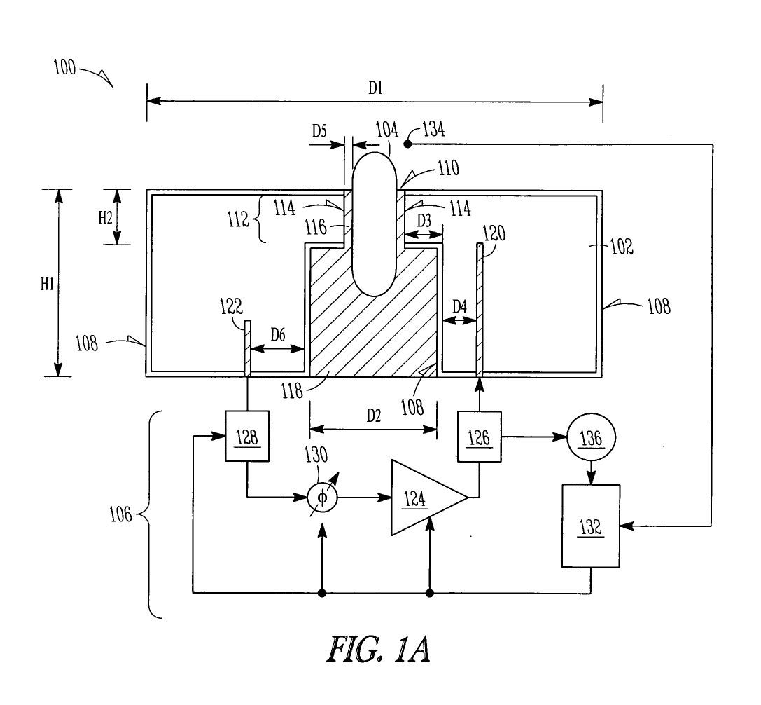

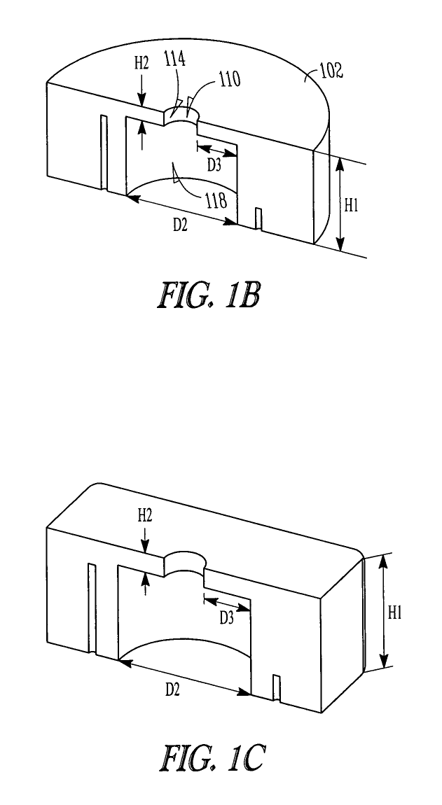

FIG. 1A is a cross-section and schematic view of a plasma lamp 100 according to an example embodiment. This is an example only and other plasma lamps may be used with other embodiments, including microwave or inductive plasma lamps. In the example of FIG. 1A, the plasma lamp may have a lamp body 102 formed from one or more solid dielectric materials and a bulb 104 positioned adjacent to the lamp body. The bulb contains a fill that is capable of forming a light emitting plasma. A lamp drive circuit 106 couples radio frequency power into the lamp body 102 which, in turn, is coupled into the fill in the bulb 104 to form the light emitting plasma. In example embodiments, the lamp body 102 forms a waveguide that contains and guides the radio frequency power. In example embodiments, the radio frequency power may be provided at or near a frequency that resonates within the lamp body 102. This is an example only and some embodiments may use a different electrodeless plasma lamp, such as a capacitively or inductively coupled plasma lamp, or other high intensity discharge lamp.

Lamp 100 has a drive probe 120 inserted into the lamp body 102 to provide radio frequency power to the lamp body 102. In the example of FIG. 1A, the lamp also has a feedback probe 122 inserted into the lamp body 102 to sample power from the lamp body 102 and provide it as feedback to the lamp drive circuit 106. A lamp drive circuit 106 including a power supply, such as amplifier 124, may be coupled to the drive probe 120 to provide the radio frequency power. The amplifier 124 may be coupled to the drive probe 120 through a matching network 126 to provide impedance matching. In an example embodiment, the lamp drive circuit 106 is matched to the load (formed by the lamp body, bulb and plasma) for the steady state operating conditions of the lamp. The lamp drive circuit 106 is matched to the load at the drive probe 120 using the matching network 126.

In example embodiments, radio frequency power may be provided at a frequency in the range of between about 50 MHz and about 10 GHz or any range subsumed therein. The radio frequency power may be provided to drive probe 120 at or near a resonant frequency for lamp body 102. The frequency may be selected based on the dimensions, shape and relative permittivity of the lamp body 102 to provide resonance in the lamp body 102. In example embodiments, the frequency is selected for a fundamental resonant mode of the lamp body 102, although higher order modes may also be used in some embodiments. In example embodiments, the RF power may be applied at a resonant frequency or in a range of from 0% to 10% above or below the resonant frequency or any range subsumed therein. In some embodiments, RF power may be applied in a range of from 0% to 5% above or below the resonant frequency. In some embodiments, power may be provided at one or more frequencies within the range of about 0 to 50 MHz above or below the resonant frequency or any range subsumed therein. In another example, the power may be provided at one or more frequencies within the resonant bandwidth for at least one resonant mode. The resonant bandwidth is the full frequency width at half maximum of power on either side of the resonant frequency (on a plot of frequency versus power for the resonant cavity).

In example embodiments, the radio frequency power causes a light emitting plasma discharge in the bulb. In example embodiments, power is provided by RF wave coupling. In example embodiments, RF power is coupled at a frequency that forms a standing wave in the lamp body (sometimes referred to as a sustained waveform discharge or microwave discharge when using microwave frequencies). In other embodiments, a capacitively coupled or inductively coupled electrodeless plasma lamp may be used. Other high intensity discharge lamps may be used in other embodiments.

Electrodeless plasma lamps, including lamps as shown in FIG. 1 and described below, may be advantageously used in microscopy and endoscopy illumination systems in example embodiments. For example, a fluorescence microscope can be used for fluorescence detection of tissue, cells or other samples for medical or biological applications or for inspection of small features such as in semiconductor devices. In some embodiments, an illumination system and microscope are used to switch between different illumination using filters. For example, filters may be used to select near ultraviolet, visible and/or infrared illumination for various applications or filters may be used for specific wavelengths to excite a particular fluorescence material. In some embodiments, filters may be used to switch between near ultraviolet and visible illumination. In some embodiments, illumination may be provided using multiple narrow near ultraviolet wavelengths to excite difference fluorescent dyes or proteins. As described below, one or more filter wheels may be rapidly switched to select illumination at the various illumination wavelengths. In some embodiments, the light beam may be split (for example by optical elements such as mirrors and lenses) and passed through multiple filters to select different wavelengths and then combined by optical elements (for example, mirrors and lenses) into a single beam for illumination at the various wavelengths.

Example embodiments of illuminations systems for microscopes and endoscopes may use an electrodeless lamp providing a broad spectrum. This allows light of various desired wavelengths to be selected using appropriate filters or filter wheels. In example embodiments, a fill including a combination of metal halides may be used to provide a broad spectrum in both the near ultraviolet and visible spectrum as described further below. A lens system may be used with the lamp with high transmission of both the near ultraviolet and visible spectrum. In addition, the lamp has a stable arc with very low noise.

Example illumination systems may also include a lamp control system that provides rapid modulation of the lamp for dimming and brightness control. Example control systems may be used to synchronize the brightness of the lamp with interference filters used in a filter wheel to select different wavelengths for illumination. When a specimen is illuminated that has multiple fluorescent materials, a filter wheel may rapidly switch between filters to illuminate each fluorescent material using the appropriate excitation wavelengths. However, the fluorescence efficiencies of the different materials may vary causing fluorescence of different light intensities. The control electronics of example embodiments may be used to adjust the brightness of the lamp for the filters used to illuminate the different materials such that a more even fluorescence is produced by the various materials. Rather than using a mechanical mechanism to reduce the light intensity, example embodiments have rapidly adjustable brightness of the plasma lamp discharge itself as described further below.

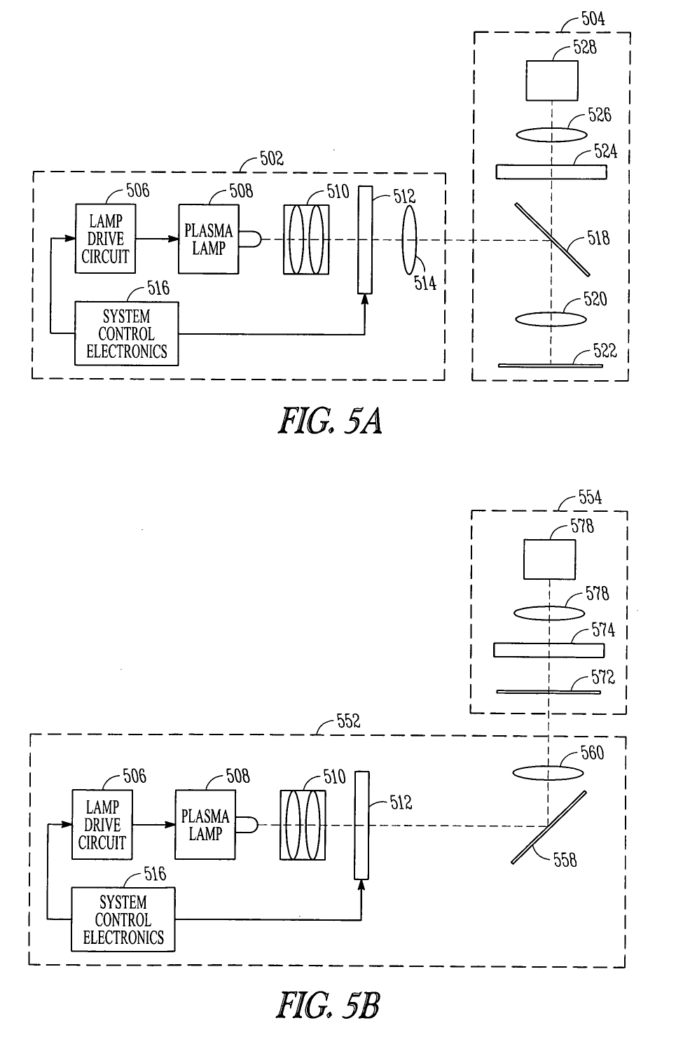

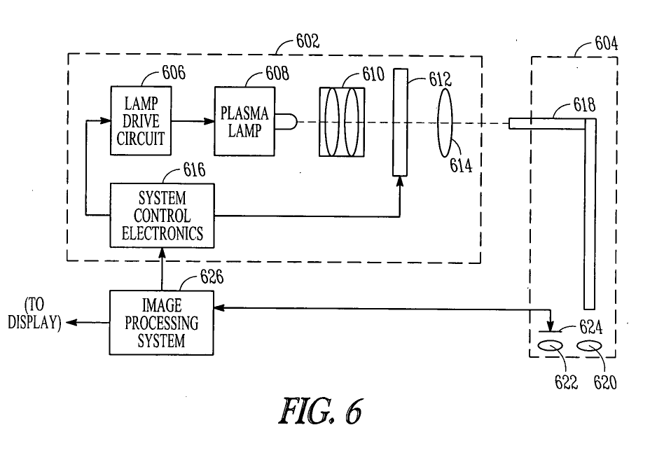

FIG. 5A is a block diagram of an example illumination system 502 for an epi illuminated fluorescence microscope 504 according to an example embodiment. In this example, the illumination system 502 includes a lamp drive circuit 506, electrodeless plasma lamp 508, lamp optics 510, filter wheel 512 and condensor lens 514, and system control electronics 516. The lamp drive circuit 506 provides radio frequency power to the lamp. The lamp 508 provides a broad spectrum that may be tailored based on the fill as described below. In example embodiments, near ultraviolet and visible light is provided. The lamp optics 510 collects light from the lamp and provides it to filter wheel 512. The lamp optics may use lenses from a material that has low absorption of the wavelengths to be transmitted. For example, fused silica may be used in some embodiments. Filter wheel 512 may include a plurality of interference filters that can be selectively moved into the light path to select different wavelengths for illumination. High speed filter wheels are available from a number of vendors, including Ludl Electronics Products Ltd. of Hawthorne, N.Y., Sutter Instrument Company of Novato, Calif., Prior Scientific, Inc. of Rockland, Mass. and Tofra, Inc. of Palo Alto, Calif. The transmitted light then passes through a condensor lens 514 and output to microscope 504. In some embodiments, a liquid light guide or other light guide may be used to provide the light to the microscope. An adapter may be used to interface the light guide to the excitation input port of the microscope.

In some embodiments, additional optics may be included in the light path. For example, mirrors and lenses may be used to split the light into multiple beams that each path through separate filters (which may be provided by multiple filter wheels). Similarly additional optics may be provided in the light path after the filters to combine the selected wavelengths into a single illumination beam.

System control electronics 516 controls the filter wheel (or multiple filter wheels) as well as the lamp drive circuit 506. In example embodiments, the selection of filters, time of illumination for each filter and switching speed may be programmed in the control electronics. In example embodiments, these parameters may be programmed in a computer that interfaces with the system control electronics. The parameters may be downloaded into a table in a memory in the system control electronics 516. A controller or processor in the system control electronics then uses these parameters to send corresponding control signals to the filter wheel 512 (or filter wheels). Similarly, the control electronics may be programmed to select a brightness level of the lamp 506 for each selected filter. The lamp output intensity may thereby be controlled to adjust for different fluorescence efficiency of the materials to be illuminated in the specimen. For example, the lamp brightness may be reduced when a filter is selected for a wavelength used to excite a material with high fluorescence efficiency. The lamp brightness may then be increased when the filter is changed to a wavelength used to excite a material with a lower fluorescence efficiency. The resulting fluorescence of the two materials will then be more even when observed in the microscope.

In example embodiments, the switching time between filters may be low. For example, the switching time may be in the range of about 20 to 200 milliseconds or any range subsumed therein. Example lamp drive circuits and lamps may have brightness modulation that is capable of switching as fast or faster than the filters. For example, the brightness may be adjusted in less than 1 to 10 milliseconds in some embodiments or any range subsumed therein. In some embodiments, as described below, a phase shifter or attenuator with a fast switching time (in one example, less than one microsecond) may be used to modulate the power to the lamp and adjust brightness. As a result, brightness can be adjusted for different filters in various applications.

Various microscopes may be used with illumination systems according to example embodiments. In the example of FIG. 5A, the microscope is an epi illumination microscope. The light used for excitation is provided to a dichroic mirror 518 or a dichroic prism. The mirror may reflect light in the range of wavelengths used for excitation of fluorescence. For example, near ultraviolet light less than about 400 nm or 420 nm may be reflected. This light passes through objective 520 to specimen 522, which then fluoresces. The resulting light then passes through mirror 518, emission filter 524, lens 526 and to detector 528. The detector 528 may be, for example, a camera or recording system, observer or other output. In other examples, where visible and near ultraviolet illumination are used (for example, to rapidly switch between exciting fluorescent materials and visible illumination for viewing), a half mirror may be used in place of or in addition to a dichroic mirror.

FIG. 5B shows another embodiment of a microscope illumination system 552. This system uses similar components to FIG. 5A and also includes mirror 556 and condensor lens 558. In this example, the microscope 554 uses a different illumination. Light passes through specimen 572, emission filter 574, and lens 576 to detector 578.

Example embodiments may also provide an illumination system for endoscopy. FIG. 6 shows an example illumination system 602 and endoscope 604. In this example, the illumination system 602 includes a lamp drive circuit 606, electrodeless plasma lamp 608, lamp optics 610, one or more filters or filter wheels 612, condensor lens 614, and system control electronics 616. The lamp drive circuit 606 provides radio frequency power to the lamp. The lamp 608 provides a broad spectrum that may be tailored based on the fill as described below. In example embodiments, near ultraviolet and visible light is provided. The lamp optics 610 collects light from the lamp and provides it to filter 612. The lamp optics may use lenses from a material that has low absorption of the wavelengths to be transmitted. For example, fused silica may be used in some embodiments. Filter wheel 612 may include a plurality of interference filters that can be selectively moved into the light path to select different wavelengths for illumination.

The light is provided to endoscope 604 which has an optical fiber 618 or other light guide and a lens 620 for illumination. Reflected light is collected by lens 622 and received by CCD 624 or other detector and provide to an image processing system 626. The image processing system can provide an image output signal to a display. Also, the image properties (contrast, brightness and the like) can be used to provide signals to the system control electronics 616. In response to those signals, system control electronics 616 can be configured to control lamp drive circuit 606 to adjust the brightness of the lamp. A computer can also interface to system control electronics 616 to change the illumination.

Following is a further description of example lamp systems that may be used in the above illumination systems. In example embodiments, a fill in a bulb is used to provide a broad spectrum for use in the above example, illumination systems.

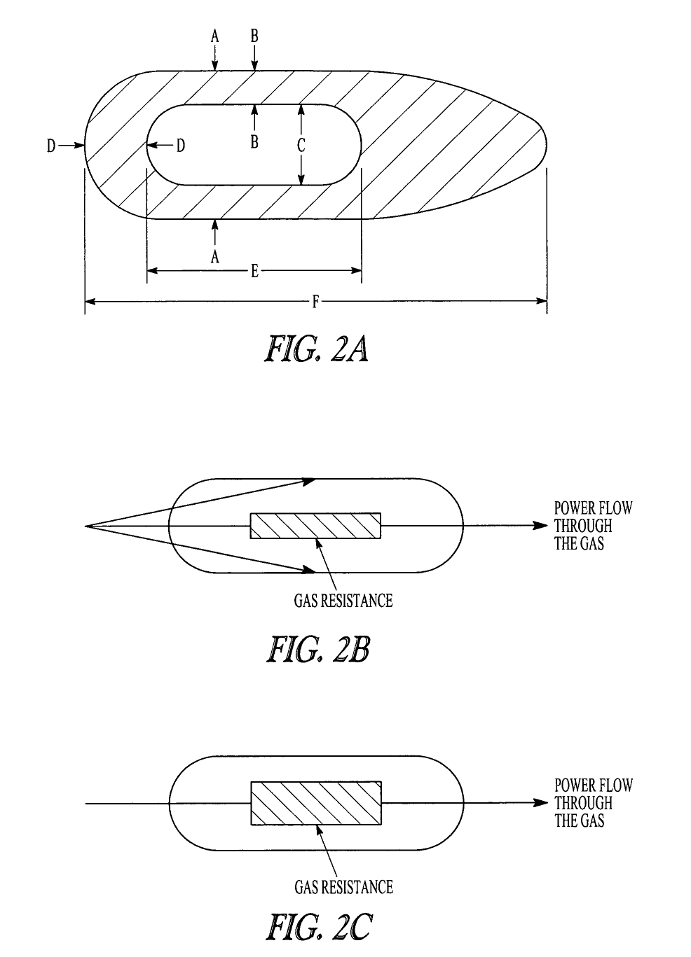

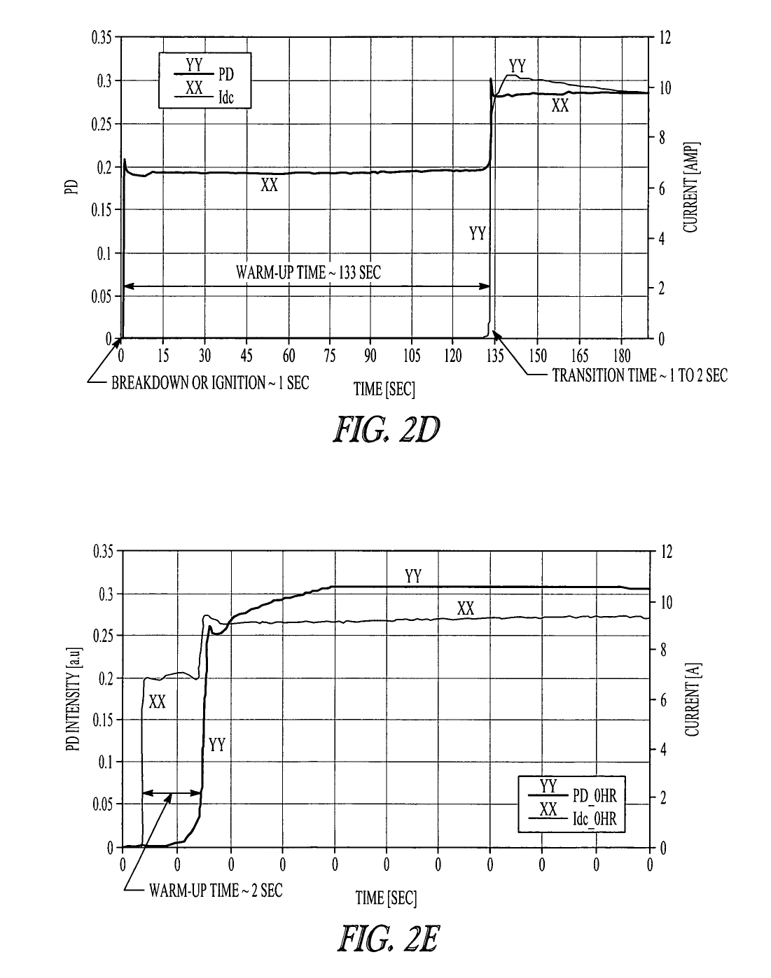

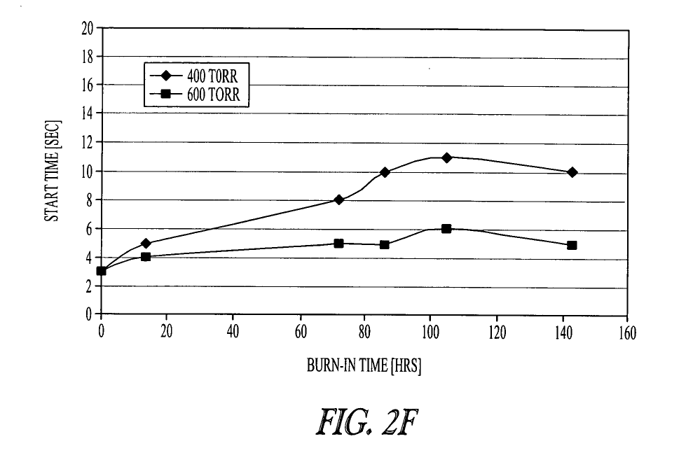

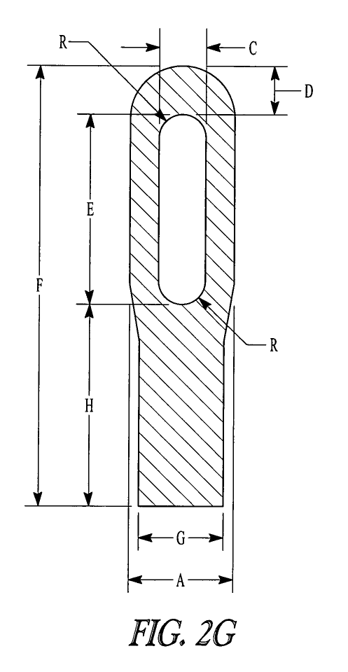

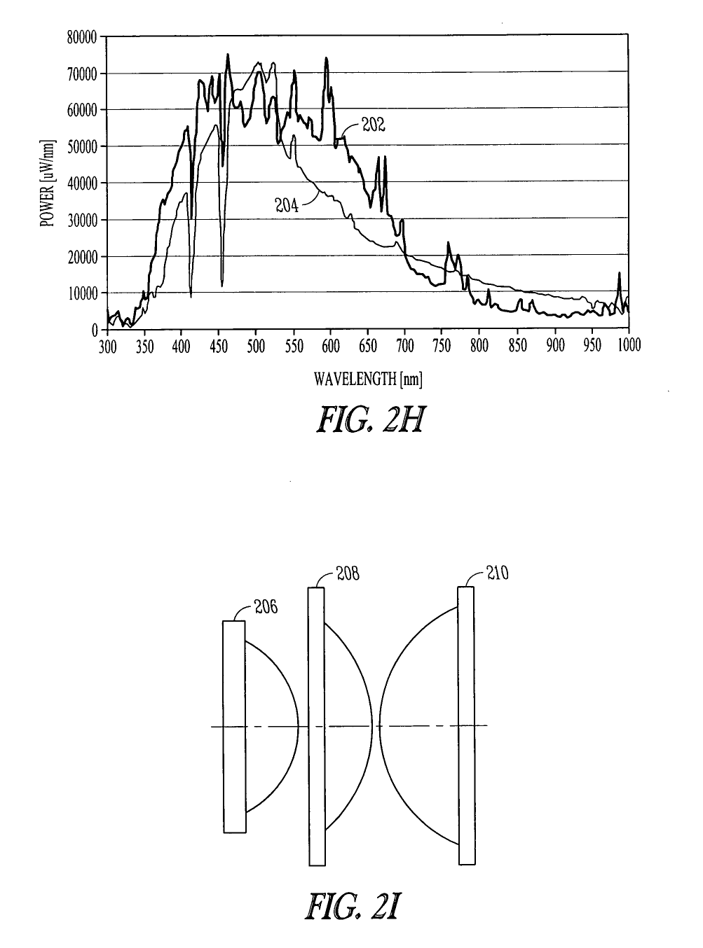

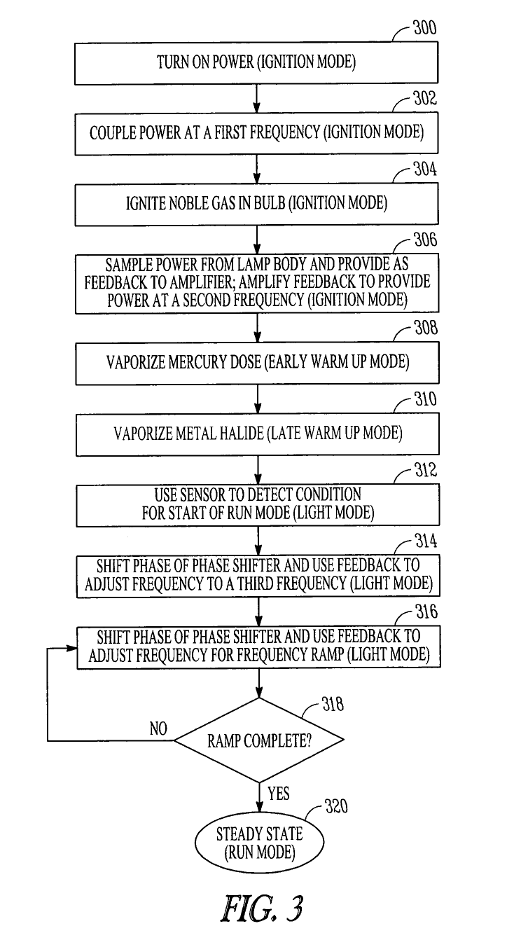

In some examples, the bulb 104 may be quartz, sapphire, ceramic or other desired bulb material and may be cylindrical, pill shaped, spherical or other desired shape. In an example embodiment shown in FIG. 2A, the bulb is cylindrical in the center and forms a hemisphere at each end. In one example, the outer length F (from tip to tip) is about 15 mm and the outer diameter A (at the center) is about 5 mm. In this example, the interior of the bulb (which contains the fill) has an interior length E of about 9 mm and an interior diameter C at the center) of about 2.2 mm. The wall thickness B is about 1.4 mm along the sides of the cylindrical portion. The wall thickness D at the front end is about 2.25 mm. The wall thickness at the other end is about 3.75 mm. In this example, the interior bulb volume is about 31.42 mm³. In example embodiments where power is provided during steady state operation at between about 150-200 watts (or any range subsumed therein), this results in a power density in the range of about 4.77 watts per mm³ to 6.37 watts per mm³ (4770 to 6370 watts per cm³) or any range subsumed therein. In this example embodiment, the interior surface area of the bulb is about 62.2 mm² (0.622 cm²) and the wall loading (power over interior surface area) is in the range of about 2.41 watts per mm² to 3.22 watts per mm² (241 to 322 watts per cm²) or any range subsumed therein.

In another example embodiment, the interior of the bulb (which contains the fill) has an interior length E of about 9 mm and an interior diameter C at the center) of about 2 mm. The wall thickness B is about 1.5 mm along the sides of the cylindrical portion. The wall thickness D at the front end (through which light is transmitted out of the lamp) is about 2.25 mm. In this example embodiment, the interior bulb volume is about 26.18 mm³. The wall thickness at the other end is about 3.75 mm. In example embodiments where power is provided during steady state operation at between about 150-200 watts (or any range subsumed therein), this results in a power density in the range of about 5.73 watts per mm³ to 7.64 watts per mm³ (5730 to 7640 watts per cm³) or any range subsumed therein. In this example embodiment, the interior surface area of the bulb is about 56.5 mm² (0.565 cm²) and the wall loading (power over interior surface area) is in the range of about 2.65 watts per mm² to 3.54 watts per mm² (265 to 354 watts per cm²) or any range subsumed therein.

In another example embodiment shown in FIG. 2G, the bulb may have a tail extending from one end of the bulb. In some embodiments, the length of the tail (indicated at H in FIG. 2G) may be between about 2 mm and 25 mm or any range subsumed therein. In some example embodiments, a longer or shorter tail may be used. In one example embodiment, the length of the tail, H, is about 9.5 mm. In this example embodiment, the outer length F (from tip to tip) is about 15 mm and the outer diameter A (at the center) is about 5 mm. In this example embodiment, the interior of the bulb (which contains the fill) has an interior length E of about 9 mm and an interior diameter C at the center) of about 2.2 mm. The wall thickness B is about 1.4 mm along the sides of the cylindrical portion. The wall thickness D at the front end is about 2.25 mm. The radius R is about 1.1 mm. In this example embodiment, the interior bulb volume is about 31.42 mm³. The tail may be formed by using a quartz tube to form the bulb. The tube is sealed at one end which forms the front end of the bulb. The bulb is filled through the open end of the tube and sealed. The sealed tube is then placed in a liquid nitrogen bath and a torch is used to collapse the tube at the other end of the lamp, which seals the bulb and forms the tail. The collapsed tube is then cut for the desired tail length.

In some example embodiments, the tail may be used to align the bulb and mount it in position. For example, recess 118 may be packed with alumina powder. A plate or cement or other material may be used to cover the back of the recess 118 and hold the powder in place. This layer forms a rigid structure to which the bulb tail may be mounted and fixed in position relative to the lamp body. For example, a layer of cement may be placed across the back surface of the powder and the tail of the bulb may be placed in the cement before it is cured. The cured cement holds the bulb in place and forms a rigid layer that is fixed in position relative to the lamp body. In some example embodiments, the tail may also provide additional heat sinking to the back end of the bulb. To the extent that the dose amounts result in a condensed pool of metal halide during lamp operation, the tail helps form the pool at the cooler region at the back of the bulb, rather than at the front of the bulb through which light is transmitted out of the lamp.

In other example embodiments, the bulb may have an interior width or diameter in a range between about 2 and 30 mm or any range subsumed therein, a wall thickness in a range between about 0.5 and 4 mm or any range subsumed therein, and an interior length between about 2 and 30 mm or any range subsumed therein. In example embodiments, the interior bulb volume may range from 10 mm³ and 750 mm³ or any range subsumed therein. In some embodiments, the bulb volume is less than about 100 mm³. In example embodiments where power is provided during steady state operation at between about 150-200 watts, this results in a power density in the range of about 1.5 watts per mm³ to 2 watts per mm³ (1500 to 2000 watts per cm³) or any range subsumed therein. In this example embodiment, the interior surface area of the bulb is about 55.3 mm² (0.553 cm²) and the wall loading (power over interior surface area) is in the range of about 2.71 watts per mm² to 3.62 watts per mm² (271 to 362 watts per cm²) or any range subsumed therein. In some embodiments, the wall loading (power over interior surface area) may be 1 watts per mm² (100 watts per cm²) or more. These dimensions are examples only and other embodiments may use bulbs having different dimensions.

In example embodiments, the bulb 104 contains a fill that forms a light emitting plasma when radio frequency power is received from the lamp body 102. The fill may include a noble gas and a metal halide. Additives such as Mercury may also be used. An ignition enhancer may also be used. A small amount of an inert radioactive emitter such as Kr₈₅ may be used for this purpose. Some example embodiments may use a combination of metal halides to produce a desired spectrum and lifetime characteristics. In some example embodiments, a first metal halide is used in combination with a second metal halide. In some example embodiments, the first metal halide is Aluminum Halide, Gallium Halide, Indium Halide, Thallium Halide and Cesium Halide and the second metal halide is a halide of a metal from the Lanthanide series. In example embodiments, the does amount of the first metal halide is in the range of from about from 1 to 50 micrograms per cubic millimeter of bulb volume, or any range subsumed therein and the dose amount of the second metal halide is in the range of from about from 1 to 50 micrograms per cubic millimeter of bulb volume, or any range subsumed therein. In some embodiments, the dose of the first metal halide and the dose of the second metal halide are each in the range of from about 10 to 10,000 micrograms or any range subsumed therein. In example embodiments, these dose amount result in a condensed pool of metal halide during lamp operation. A noble gas and additives such as Mercury may also be used. In example embodiments, the dose amount of Mercury is in the range of 10 to 100 micrograms of Mercury per mm³ of bulb volume, or any range subsumed therein. In some embodiments, the dose of Mercury may be in the range of from about 0.5 to 5 milligrams or any range subsumed therein. An ignition enhancer may also be used. A small amount of an inert radioactive emitter such as Kr₈₅ may be used for this purpose. In some example embodiments, Kr₈₅ may be provided in the range of about 5 nanoCurie to 1 microCurie or any range subsumed therein.

In a particular example embodiment, the fill includes the first metal halide as an Iodide or Bromide in the range from about 0.05 mg to 0.3 mg or any range subsumed therein, and the second metal halide as an Iodide or Bromide in the range from about 0.05 mg to 0.3 mg or any range subsumed therein. Chlorides may also be used in some embodiments. In some example embodiments, the first metal halide and the second metal halide are provided in equal amounts. In other embodiments, the ratio of the first metal halide to the second metal halide may be 10:90, 20:80, 30:70, 40:60, 60:40, 70:30, 80:20 or 90:10.

In some example embodiments, the first metal halide is Aluminum Halide, Gallium Halide, Indium Halide or Thallium Halide (or a combination of Aluminum Halide, Gallium Halide, Indium Halide and/or Thallium Halide). In some example embodiments, the first metal halide may be Cesium Halide (or Cesium Halide in combination with Aluminum Halide, Gallium Halide, Indium Halide and/or Thallium Halide). In other example embodiments, the dose does not include any Alkali metals. In some example embodiments, the second metal halide is Holmium Halide, Erbium Halide or Thulium Halide (or a combination of one or more of these metal halides). In these example embodiments, the first metal halide may be provided in a dose amount in the range of about 0.3 mg/cc to 3 mg/cc or any range subsumed therein and the second metal halide may be provided in a dose amount in the range of about 0.15 mg/cc to 1.5 mg/cc or any range subsumed therein. In some example embodiments, the first metal halide may be provided in a dose amount in the range of about 0.9 mg/cc to 1.5 mg/cc or any range subsumed therein and the second metal halide may be provided in a dose amount in the range of about 0.3 mg/cc to 1 mg/cc or any range subsumed therein. In some example embodiments, the first metal halide is provided in a larger dose amount than the second metal halide. In some examples, the first metal halide is Aluminum Bromide or Indium Bromide and the second metal halide is Holmium Bromide. In some example embodiments, the fill also includes Argon or another noble gas at a pressure in the range of about 50 to 760 Torr or any range subsumed therein. In some example embodiments, the pressure is 100 Torr or more or 150 Torr or more or may be at higher pressures as described below. In one example, Argon at 150 Torr may be used. Mercury and an inert radioactive emitter such as Kr₈₅ may also be included in the fill. In some example embodiments, a power of 100 watts or more may be provided to the lamp. In some example embodiments, the power is in the range of about 150 to 200 watts, with 170 watts being used in a particular example. The wall loading may be 1 watts per mm² (100 watts per cm²) or more. A thermally conductive material, such as alumina powder, may be in contact with the bulb to allow high wall loading to be used as described below. In some example embodiments, as described further below, these fills may be used to provide 15,000 to 20,000 lumens (or any range subsumed therein) when operated at 150 to 200 watts (or any range subsumed therein). This can provide a luminous efficiency of 100 lumens per watt or more in some embodiments. Example embodiments may also provide at a correlated color temperature of 4000 to 10000 K (or any range subsumed therein) with a bulb geometry enabling the collection of 4500 to 5500 lumens (or any range subsumed therein) in 27 mm2 steradian when operated at 150 to 200 watts (or any range subsumed therein). In some example embodiments, the fill may be selected to provide a correlated color temperature in the range of 6000 to 9000 K.

Other metal halides may also be used in other example embodiments, including Bromides, Iodides and Chlorides of Indium, Aluminum, Gallium, Thallium, Holmium, Dysprosium, Cerium, Cesium, Erbium, Thulium, Lutetium and Gadolinium. Other metal halides may also be used in other embodiments, including Bromides, Iodides and Chlorides of Sodium, Calcium, Strontium, Yttrium, Tin, Antimony, Thorium and any of the elements in the Lanthanide series.

Some example embodiments may use a combination of metal halides to produce a desired spectrum. In some examples, one or more metal halides with strong emission in the blue color range (such as halides of Aluminum, Cesium, Gallium, Indium and/or Scandium) may be combined with one or more metal halides to enhance emission in the red color range (such as halides of Sodium, Calcium, Strontium, Gadolinium, Dysprosium, Holmium, Erbium and/or Thulium). In particular example embodiments, the fill may include (1) Aluminum Halide and Holmium Halide; (2) Aluminum Halide and Erbium Halide; (3) Gallium Halide and Holmium Halide; (4) Gallium Halide and Erbium Halide; (5) any of these fill further including Indium Halide; (6) any of these fills further including an alkali metal halide such as Sodium Halide or Cesium Halide (although other examples may specifically exclude all alkali metals); and (7) any of these fills further including Cerium Halide.

In an example embodiment, the metal halide(s) may be provided in the range from about 0.01 mg to 10 mg or any range subsumed therein and Mercury may be provided in the range of about 0.01 to 10 mg or any range subsumed therein. In example embodiments, the fill includes 1 to 100 micrograms of metal halide per mm³ of bulb volume, or any range subsumed therein, 1 to 100 micrograms of Mercury per mm³ of bulb volume, or any range subsumed therein, and 5 nanoCurie to 1 microCurie of a radioactive ignition enhancer, or any range subsumed therein. In other examples, the fill may include a dose of one or more metal halides in the range of about 1 to 100 micrograms of metal halide per mm³ of bulb volume without Mercury. In some embodiments using more than one metal halide, the total dose may be in any of the above ranges and the percentage of each metal halide may range from 5% to 95% of the total dose or any range subsumed therein.

These doses are examples only and other embodiments may use different doses and/or different fill materials. In other embodiments, different fills such as Sulfur, Selenium or Tellurium may also be used. In some examples, a metal halide such as Cesium Bromide may be added to stabilize a discharge of Sulfur, Selenium or Tellurium. Metal halide may also be added to a fill of Sulfur, Selenium or Tellurium to change the spectrum of the discharge.

In some example embodiments, a high pressure fill is used to increase the resistance of the gas. This can be used to decrease the overall startup time required to reach full brightness for steady state operation. In one example, a noble gas such as Helium, Neon, Argon, Krypton or Xenon, or another substantially non-reactive gas such as Nitrogen, or a combination of these gases is provided at high pressures between 200 Torr to 3000 Torr or any range subsumed therein. Pressures less than or equal to 760 Torr may be desired in some embodiments to facilitate filling the bulb at or below atmospheric pressure. In particular embodiments, pressures between 400 Torr and 600 Torr are used to enhance starting. Example high pressure fills may also include metal halide (or a combination of metal halides as described above) and Mercury which have a relatively low vapor pressure at room temperature. Example metal halide and Mercury fills include, but are not limited to, the fills described in Table 1 below. A bulb as described in connection with FIG. 2A or FIG. 2G may be used with these fills in example embodiments. In one example, the bulb has a volume of about 31.42 mm³ as described above.

TABLE 1

| Fill | InBr | DyI₃ | CeI₃ | HoBr₃ | AlBr₃ | ErBr₃ | GdI₃ | HoI₃ | Hg |
|---|---|---|---|---|---|---|---|---|---|
| #1 | 0.1 mg | 0.1 mg | 0 | 0 | 0 | 0 | 0 | 0 | 2.7 mg |
| #2 | 0.1 mg | 0 | 0.1 mg | 0 | 0 | 0 | 0 | 0 | 2.7 mg |
| #3 | 0 | 0 | 0 | 0.05 mg | 0.05 mg | 0 | 0 | 0 | 1.35 mg |
| #4 | 0.1 mg | 0 | 0 | 0 | 0.1 mg | 0 | 0 | 0 | 2.7 mg |
| #5 | 0.1 mg | 0 | 0 | 0 | 0 | 0 | 0.1 mg | 0 | 2.7 mg |
| #6 | 0.1 mg | 0 | 0 | 0 | 0 | 0 | 0 | 0.1 mg | 2.7 mg |
| #7 | 0.1 mg | 0 | 0 | 0 | 0 | 0 | 0 | 0 | 1.6 mg |
| #8 | 0 | 0 | 0 | 0 | 0.05 mg | 0.05 mg | 0 | 0 | 1.35 mg |
| #10 | 0.03 mg | 0 | 0 | 0.01 mg | 0 | 0 | 0 | 0 | 1.4 mg |
| #11 | 0.03 mg | 0 | 0 | 0.03 mg | 0 | 0 | 0 | 0 | 1.4 mg |
| #12 | 0.05 mg | 0 | 0 | 0.01 mg | 0 | 0 | 0 | 0 | 1.4 mg |
| #13 | 0.05 mg | 0 | 0 | 0.03 mg | 0 | 0 | 0 | 0 | 1.4 mg |

In example embodiments, these dose amount result in a condensed pool of metal halide during lamp operation. These fills can also be used without Mercury in some embodiments. In these examples, Argon or Krypton is provided at a pressure in the range of about 400 Torr to 760 Torr, depending upon desired startup characteristics. Some embodiments may use higher pressures. Initial breakdown of the noble gas is more difficult at higher pressure, but the overall warm up time required for the fill to substantially vaporize and reach peak brightness is reduced. The above fills may be used with or without an ignition enhancer. In some embodiments, these fills include Kr₈₅ in the range of about 5 nanoCurie to 1 microCurie or any range subsumed therein. Higher levels of ignition enhancer can be used to provide almost instantaneous ignition. The above pressures are measured at 22° C. (room temperature). It is understood that much higher pressures are achieved at operating temperatures after the plasma is formed. For example, the lamp may provide a high intensity discharge at high pressure during operation (e.g., greater than 2 atmospheres and 10-100 atmospheres or more in example embodiments or any range subsumed therein). These pressures and fills are examples only and other pressures and fills may be used in other embodiments.

In a particular example embodiment, the bulb has a volume of about 31.42 mm cubed and the fill includes 0.01 milligram of InBr and 0.005 mg of HoBr3. In another example embodiment, the bulb has a volume of about 31.42 mm cubed and the fill includes 0.01 milligram of InBr and 0.005 mg of ErBr3. These fills may also include 1.4 mg of Mercury or may be Mercury free in some example embodiments. The fill may also include Kr₈₅ as an ignition enhancer in the does ranges described above. In this example embodiment, Argon or Krypton is provided at a pressure in the range of about 100 Torr to 200 Torr, depending upon desired startup characteristics. Some embodiments may use higher pressures. Initial breakdown of the noble gas is more difficult at higher pressure, but the overall warm up time required for the fill to substantially vaporize and reach peak brightness is reduced.

FIG. 2H shows an example spectral power distribution 202 for a lamp of the type shown in FIG. 1A containing the example InBr/HoBr3 fill in microwatts per nanometer as collected in 27 mm² steradian at about 140 W operating power provided to the lamp. FIG. 2H also shows an example spectral power distribution 204 for an Indium Bromide fill for comparison. As shown in FIG. 2H, the Indium/Holmium fill provides a brighter and more balanced spectrum. For example, the total radiated power between about 300-1000 nm collected in 27 mm² steradian at about 140 W operating power provided to the lamp is about 20.2 watts compared to 17.2 watts for Indium Bromide alone. In the range of 320 nm to 400 nm (part of the near UV spectrum, which may be useful for fluorescence excitation) the collected radiated power is about 1.8 watts for the In/Ho fill and 1.02 watts for In only. In the range of 340 nm to 420 nm (which may be a useful range for excitation of fluorescence in some applications) the collected radiated power is about 2.7 watts for the In/Ho fill and 1.55 watts for In only. In the range of 365 nm to 400 nm the collected radiated power is about 1.4 watts for the In/Ho fill and 0.8 watts for In only. In the range of 400 nm to 700 nm (for visible illumination) the collected radiated power is about 15.9 watts for the In/Ho fill and 12.7 watts for In only. Each of the above can be expressed as a percentage of the total collected radiated power from 300 to 1000 nm in 27 mm² steradian and also as a percentage of input power to the lamp (in this case about 140 watts). For the near ultraviolet and the ranges above, it may be desirable to select a fill with higher values than the In only fill for fluorescence excitation applications, such as the microscopy and endoscopy illumination systems described above. Use of metal halide from the Lanthanide series, such as Holmium Halide or Erbium Halide, can be used to achieve an enhanced spectrum for these applications and may also be combined with Indium Halide or other metal halides as described above. Also, the color rendering for the Indium/Holmium fill is greater than 95% (about 97% in some embodiments) compared to 85% to 89% for Indium only fills. The improved color rendering may also be used to improve visible illumination in microscopy and endoscopy systems as described above. In example embodiments, the above characteristics are obtained for collected light in 30 mm² steradian or less.

The plasma arc produced in example embodiments is stable with low noise. Power is coupled symmetrically into the center region of the bulb from the lamp body and is not disturbed by electrodes in the bulb (or degradation of those electrodes). As a result, the lamp has low noise which provides enhanced illumination for microscopy and endoscopy applications. For example, root-mean-squared (RMS) noise of the light output from the lamp may be less than 1% and even less than 0.5% in example embodiments. Many arc lamps used for microscopy and endoscopy applications are believed to have higher RMS noise.

FIG. 2I shows a lens system that may be used for example embodiments. As shown in FIG. 2I, a lens triplet may be used at the output of the lamp, including a meniscus lens 206, first aspheric lens 208 and second aspheric lens 210. The lens system collects light from the lamp as described above and may be used as shown at 510 in FIGS. 5A and 5B above and at 610 in FIG. 6. The lenses may be fused silica which has less absorption of near UV than soda lime glass lenses used in other embodiments. For example, the absorption through 25 mm at 365 nm is about 14% less than a soda lime glass used in other embodiments. Also, the fused silica is less susceptible to solarization from exposure to UV. An anti-reflective coating may be used with less than about 0.5% reflection from 340 nm to 540 nm. The spectrum in FIG. 2H was measure using a soda lime glass lens and is expected to be improved for near UV using fused silica.

The operation of an example lamp will now be described with reference to FIG. 1A and FIG. 4. The power to the lamp body 102 may be controlled to provide a desired startup sequence for igniting the plasma. As the plasma ignites and heats up during the startup process, the impedance and operating conditions of the lamp change. In order to provide for efficient power coupling during steady state operation of the lamp, the lamp drive circuit 106 is impedance matched to the steady state load of the lamp body, bulb and plasma after the plasma is ignited and reaches steady state operating conditions. This allows power to be critically coupled from the drive circuit 106 to the lamp body 102 and plasma during steady state operation. However, the power from the drive circuit 106 is overcoupled to the lamp body 102 at ignition and during warm up of the plasma.

When the power is initially turn on, the load appears as an open circuit and the power is substantially reflected. However, the gas in the bulb ignites and breaks down almost immediately as indicated at 400 in FIG. 4. After ignition, the impedance is low and much of the power from the drive circuit 106 is reflected. For example, the amplifier 124 may provide about 170 watts of forward power, but more than half of this power may be reflected at startup. The net power to the lamp may be only between about 40-100 watts (or any range subsumed therein) after ignition and prior to substantial vaporization of the Mercury and metal halide (when the lamp transitions to high brightness), and the rest may be reflected. In other examples, 40-80%, or any range subsumed therein, of the forward power from the amplifier may be reflected during warm up.

The breakdown of the noble gas then heats the walls of the bulb, which leads to vaporization of the Mercury and metal halide as indicated at 402 in FIG. 4. Once the Mercury and metal halide is vaporized, the lamp reaches high brightness and power is more effectively coupled into the plasma. However, if the breakdown of the noble gas does not provide enough heat, vaporization of the Mercury and metal halide will be slow and the lamp will not reach full brightness quickly.

FIGS. 2A and 2B illustrate the power flow through a bulb at a low pressure of less than 200 Torr and at more than 400 Torr, respectively. In the example lamp of FIG. 1A, a TM fundamental resonant mode may be used and the resulting electric field is approximately parallel to the length of the bulb. As shown in FIGS. 2A and 2B the direction of power flow through the bulb is approximately parallel to the length of the bulb.

The bulb shown in FIG. 2A represents a bulb with a fill including Argon at a pressure of less than about 200 Torr as well as Mercury and metal halide. The impedance after breakdown is very small and is estimated to be about 1 ohm. When the net power is low, the amount of heat generated is not sufficient to increase the wall temperature to rapidly evaporate the Mercury and metal halide in the bulb. In one example with a low pressure fill, the net power during warm up is about 20 watts or less and the lamp startup may take several minutes to reach high brightness (including the time for breakdown of Argon, early warm up/vaporization of Mercury, late warm up/vaporization of metal halide and transition time). An example startup time for a low pressure fill is illustrated in FIG. 2D. As shown in FIG. 2D, the breakdown and transition time are relatively short, but the warm up time takes about 133 seconds (about 98% of the startup time). In one example, in order to achieve a desired startup time at 200 Torr, a forward power of about 244 W or more is required.

The bulb shown in FIG. 2B represents a bulb with a fill including Argon at a pressure of more than about 400 Torr as well as Mercury and Indium Bromide. The impedance after breakdown is estimated to be more than 10 times the impedance for the bulb shown in FIG. 2A (more than 10 ohms). An example startup time for a high pressure fill is illustrated in FIG. 2E. As shown in FIG. 2E, the warm up time is short and may be less than 2 seconds in some embodiments. As shown in FIG. 2E, the warm up starts upon ignition and breakdown of the noble gas and continues until the lamp transitions to high brightness. FIG. 2E shows the intensity of light output detected by a photodiode (PD) during startup. In this example, the warm up time is indicated at a photodiode intensity of about 0.06, which is about 20% of the peak output intensity. The time from ignition to the beginning of the transition curve (e.g., around 3-5% of peak intensity) is even shorter and is slightly over a second in this example. The lamp then transitions to high brightness. The transition period from warm up to 80% peak brightness in this example is about one second. In example embodiments, it is believed that ignition time can be reduced to a fraction of a second (for example, using increased ignition enhancer) and that higher pressure noble gas can be used to further reduce warm up time (e.g., to 1-2 seconds or less). As a result, it is believed that very fast startup times of 1-3 seconds may be achieved even though the net power is limited due to the impedance mismatch during startup. FIG. 2E also shows the DC current (Idc) provided by the amplifier. As shown in FIG. 2E, the DC current may be limited during warm up. This may help reduce the potential for damage to the lamp drive circuit during periods of high reflection. After transition (e.g., 80% peak brightness) in this example, the DC current is raised to a higher level. In the example of FIG. 2E, the DC current is less than 8 Amperes during warm up and more than 8 Amperes during steady state operation, even though the impedance is substantially lower during warm up (e.g., about 10 ohms) than during steady state (e.g., about 50 ohms).

FIG. 2F shows the effect of lamp burn in on start up times in example embodiments. With an example net power of about 60 watts during warm up, the startup time at 400 Torr may take only about 10 seconds and the startup time at 600 Torr may take only about 5 seconds. This startup time is measured after lamp burn-in of 72 hours or more. At pressures above 400 Torr, a sparker or other ignition aid may be used for initial ignition. Aging of the bulb may facilitate fill breakdown, and the fill may ignite without a separate ignition aid after burn-in of about 72 hours. In addition, the presence of hydrogen impurities shortens warm up time, but hydrogen diffuses out after about 72 hours. FIG. 2F shows a chart illustrating the change in startup time for a bulb at 400 Torr and 600 Torr over burn-in period of about 140 hours. As seen in FIG. 2F, the startup time stabilizes at about 10 seconds for 400 Torr and 5 seconds for 600 Torr after burn-in.

The lamp drive circuit 106 and startup procedure for lamp 100 will now be described in further detail. As shown in FIG. 1A, the amplifier 124 may be coupled to the drive probe 120 through a matching network 126 to provide impedance matching. In an example embodiment, the amplifier 124 is matched to about 50 ohms for the steady state operating conditions of the lamp.

In example embodiments, the amplifier 124 may be operated in multiple operating modes at different bias conditions to improve starting and then to improve overall amplifier efficiency during steady state operation. For example, the amplifier may be biased to operate in Class A/B mode to provide better dynamic range during startup and in Class C mode during steady state operation to provide more efficiency. The amplifier may also have a gain control that can be used to adjust the gain of the amplifier 124. Amplifier 124 may include either a plurality of gain stages or a single stage.

The feedback probe 122 is coupled to the input of the amplifier 124 through an attenuator 128 and phase shifter 130. The attenuator 128 is used to adjust the power of the feedback signal to an appropriate level for input to the phase shifter 130. In some embodiments, a second attenuator may be used between the phase shifter 130 and the amplifier 124 to adjust the power of the signal to an appropriate level for amplification by the amplifier 124. In some embodiments, the attenuator(s) may be variable attenuators controlled by the control electronics 132. In other embodiments, the attenuators may be set to a fixed value. In some embodiments, the lamp drive circuit may not include an attenuator. In an example embodiment, the phase shifter 130 may be a voltage-controlled phase shifter controlled by the control electronics 132.

The feedback loop automatically oscillates at a frequency based on the load conditions and phase of the feedback signal. This feedback loop may be used to maintain a resonant condition in the lamp body 102 even though the load conditions change as the plasma is ignited and the temperature of the lamp changes. If the phase is such that constructive interference occurs for waves of a particular frequency circulating through the loop, and if the total response of the loop (including the amplifier, lamp, and all connecting elements) at that frequency is such that the wave is amplified rather than attenuated after traversing the loop, the loop will oscillate at that frequency. Whether a particular setting of the phase-shifter induces constructive or destructive feedback depends on frequency. The phase-shifter 128 can be used to finely tune the frequency of oscillation within the range supported by the lamp's frequency response. In doing so, it also effectively tunes how well RF power is coupled into the lamp because power absorption is frequency-dependent. Thus, the phase-shifter 128 provides fast, finely-tunable control of the lamp output intensity. Both tuning and detuning are useful. For example: tuning can be used to maximize intensity as component aging changes the overall loop phase; detuning can be used to control lamp dimming. In some example embodiments, the phase selected for steady state operation may be slightly out of resonance, so maximum brightness is not achieved. This may be used to leave room for the brightness to be increased and/or decreased by control electronics 130.

In FIG. 1A, control electronics 132 is connected to attenuator 128, phase shifter 130 and amplifier 124. The control electronics 132 provide signals to adjust the level of attenuation provided by the attenuator 128, phase of phase shifter 130, the class in which the amplifier 124 operates (e.g., Class A/B, Class B or Class C mode) and/or the gain of the amplifier 124 to control the power provided to the lamp body 102. In one example, the amplifier 124 has three stages, a pre-driver stage, a driver stage and an output stage, and the control electronics 132 provides a separate signal to each stage (drain voltage for the pre-driver stage and gate bias voltage of the driver stage and the output stage). The drain voltage of the pre-driver stage can be adjusted to adjust the gain of the amplifier. The gate bias of the driver stage can be used to turn on or turn off the amplifier. The gate bias of the output stage can be used to choose the operating mode of the amplifier (e.g., Class A/B, Class B or Class C). Control electronics 130 can range from a simple analog feedback circuit to a microprocessor/microcontroller with embedded software or firmware that controls the operation of the lamp drive circuit. The control electronics 130 may include a lookup table or other memory that contains control parameters (e.g., amount of phase shift or amplifier gain) to be used when certain operating conditions are detected. In example embodiments, feedback information regarding the lamp's light output intensity is provided either directly by an optical sensor 134, e.g., a silicon photodiode sensitive in the visible wavelengths, or indirectly by an RF power sensor 136, e.g., a rectifier. The RF power sensor 136 may be used to determine forward power, reflected power or net power at the drive probe 120 to determine the operating status of the lamp. A directional coupler may be used to tap a small portion of the power and feed it to the RF power sensor 136. An RF power sensor may also be coupled to the lamp drive circuit at the feedback probe 122 to detect transmitted power for this purpose. In some embodiments, the control electronics 132 may adjust the phase shifter 130 on an ongoing basis to automatically maintain desired operating conditions.

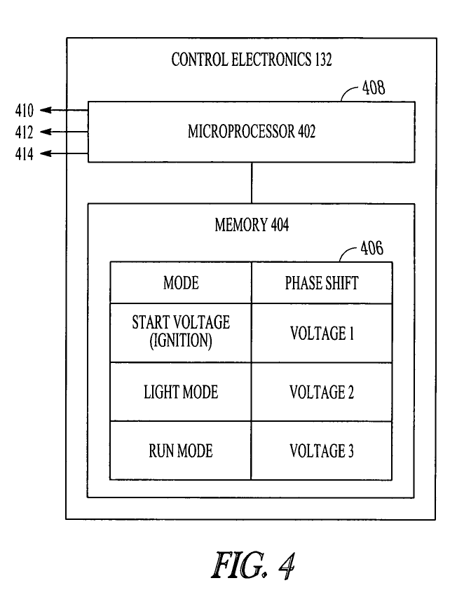

FIG. 3 is a flow chart of an example startup procedure for a fill that includes a noble gas, Mercury and metal halide. In one example, the fill includes 400-600 Torr of Argon, 1.608 mg Mercury, 0.1 mg Indium Bromide and about 10 nanoCurie of Kr₈₅. In this example, the lamp 100 starts at a frequency of about 895 MHz at power on (step 300 in FIG. 3) and the Argon ignites almost immediately (step 302 in FIG. 3). Upon ignition, the frequency drops to about 880 MHz due to the change in impedance from the ignition of the Argon. The frequency is automatically adjusted by the feedback loop as indicated at 306 in FIG. 3. The Mercury then vaporizes and heats up as indicated at 308. The Indium Bromide also vaporizes and light is emitted at high brightness as indicated at 310. When this light is detected by sensor 134, the phase shifter 130 is automatically adjusted to accommodate for the change in frequency due to the change in the impedance of the plasma as indicated at 314. In one example, the threshold may be triggered by detection of visible light output intensity in the range of from about 20%-90% of peak light output intensity. In particular examples, 80% or 90% of peak output intensity is used as a threshold. In other examples, the threshold may be determined based on forward and/or reflected power detected by the lamp drive circuit. With the appropriate phase shift, the feedback loop adjusts the frequency to about 885 MHz. In an example embodiment, when this startup process is used with a high pressure fill as described above, the startup process from power on to substantial vaporization of the fill (steps 300 to 314 in FIG. 3) may be completed in about 5-10 seconds or less. As a result, high brightness can be achieved very rapidly.

As the plasma continues to heat up, the impedance continues to change and the frequency continues to drop until the lamp reaches steady state operating conditions. In example embodiments, the impedance after warm up is in the range of 40-60 ohms or any range subsumed therein. In a particular embodiment, the impedance is about 50 ohms during steady state operation. As the frequency changes, the phase of the phase shifter 130 may continue to be adjusted to match the changes in frequency. In an example startup procedure, the frequency ramps down to a steady state operating frequency of about 877 MHz. This ramp may take several minutes. In order to avoid a drop in brightness, the control electronics 132 adjusts the phase of the phase shifter 130 in stages to match the ramp. As shown in FIG. 4, a lookup table 406 in the control electronics 132 may be used to store a sequence of parameters indicating the amount of phase shift to be used by the control electronics 132 during the startup procedure. In one example, the voltage to be applied to the phase shifter is stored in the lookup table for startup (ignition), high (e.g., 80-90% of peak) brightness of the plasma (light mode) and steady state after the lamp is heated (run mode). A microprocessor 402 in control electronics 132 may use these parameters to shift the phase in increments between the time that transition to high brightness is detected and completion of heat up. In one example, firmware executed by the microprocessor 402 linearly interpolate between the desired phase at substantial vaporization (light mode) when the frequency is about 885 MHz and the desired phase at the end of heat up (run mode) when the frequency is about 877 MHz. In one example, firmware in the control electronics linearly interpolates sixteen values for the phase voltage that are applied in equal increments over a period of about 5 minutes as the lamp ramps from light mode to run mode. The phase adjustments and ramp may be determined empirically and programmed into the lookup table based on the operating conditions of the particular lamp. In order to adjust the phase, the microprocessor 402 outputs a voltage signal on a control line 410 which is connected to the phase shifter 130 (the other control lines 412 and 414 may be used to control the attenuator 126 and the amplifier 124). The phase adjustments continue in sequence until the ramp is complete as indicated at 318 in FIG. 3.

In an alternative embodiment, the control electronics 132 may automatically shift the phase periodically to determine whether a change in one direction or another results in more efficient power coupling and/or higher brightness (based on feedback from an optical sensor or rf power sensor in the drive circuit). This periodic phase shift can be performed very rapidly, so an observer does not notice any visible change in the light output intensity.

The phase of the phase shifter 130 and/or gain of the amplifier 124 may also be adjusted after startup to change the operating conditions of the lamp. For example, the power input to the plasma in the bulb 104 may be modulated to modulate the intensity of light emitted by the plasma. In other embodiments, a variable attenuator may be used in the lamp drive circuit for this purpose. An attenuator and/or phase shifter with fast switching time (in one example, less than one microsecond) can be used for fast modulation of an electrodeless plasma lamp. This can be used for brightness adjustment or to modulate the light to adjust for image effects in microscopy and endoscopy systems as described above. For example, brightness may be adjusted for different filters and excitation of materials with different fluorescence efficiency. This may allow rapid adjustment of power (faster than filter switching time), for example, less than about 10 milliseconds or 1 millisecond in some examples. Also, systems using spatial light modulators may have brightness adjusted for different color segments for color balancing.

In another example, the phase shifter 130 can be modulated to spread the power provided by the lamp circuit 106 over a larger bandwidth. This can reduce ElectroMagnetic Interference (EMI) at any one frequency and thereby help with compliance with FCC regulations regarding EMI. In example embodiments, the degree of spectral spreading may be from 5-30% or any range subsumed therein. In one example, the control electronics 132 may include circuitry to generate a sawtooth voltage signal and sum it with the control voltage signal to be applied to the phase shifter 130. In another example, the control electronics 132 may include a microcontroller that generates a Pulse Width Modulated (PWM) signal that is passed through an external low-pass filter to generate a modulated control voltage signal to be applied to the phase shifter 130. In example embodiments, the modulation of the phase shifter 130 can be provided at a level that is effective in reducing EMI without any significant impact on the plasma in the bulb.

In example embodiments, the amplifier 124 may also be operated at different bias conditions during different modes of operation for the lamp. The bias condition of the amplifier 124 has a large impact on DC-RF efficiency. For example, an amplifier biased to operate in Class C mode is more efficient than an amplifier biased to operate in Class B mode, which in turn is more efficient than an amplifier biased to operate in Class A/B mode. However, an amplifier biased to operate in Class A/B mode has a better dynamic range than an amplifier biased to operate in Class B mode, which in turn has better dynamic range than an amplifier biased to operate in Class C mode.

In one example, when the lamp is first turned on, amplifier 124 is biased in a Class A/B mode. Class A/B provides better dynamic range and more gain to allow amplifier 124 to ignite the plasma and to follow the resonant frequency of the lamp as it adjusts during startup. Once the plasma reaches its steady state operating condition (run mode), the amplifier bias is removed which puts amplifier 124 into a Class C mode. This provides improved efficiency. However, the dynamic range in Class C mode may not be sufficient when the brightness of the lamp is modulated below a certain level (e.g., less than 70% of full brightness). When the brightness is lowered below the threshold, the amplifier 124 may be changed back to Class A/B mode. Alternatively, Class B mode may be used in some embodiments.

Additional aspects of electrodeless plasma lamps according to example embodiments will now be described with reference to FIGS. 1A, 1B and 1C. In example embodiments, the lamp body 102 has a relative permittivity greater than air. The frequency required to excite a particular resonant mode in the lamp body 102 generally scales inversely to the square root of the relative permittivity (also referred to as the dielectric constant) of the lamp body. As a result, a higher relative permittivity results in a smaller lamp body required for a particular resonant mode at a given frequency of power. The shape and dimensions of the lamp body 102 also affect the resonant frequency as described further below. In an example embodiment, the lamp body 102 is formed from solid alumina having a relative permittivity of about 9.2. In some embodiments, the dielectric material may have a relative permittivity in the range of from 2 to 100 or any range subsumed therein, or an even higher relative permittivity. In some embodiments, the body may include more than one such dielectric material resulting in an effective relative permittivity for the body within any of the ranges described above. The body may be rectangular, cylindrical or other shape as described further below.

In example embodiments, the outer surfaces of the lamp body 102 may be coated with an electrically conductive coating 108, such as electroplating or a silver paint or other metallic paint which may be fired onto the outer surface of the lamp body. The electrically conductive material 108 may be grounded to form a boundary condition for the radio frequency power applied to the lamp body 102. The electrically conductive coating helps contain the radio frequency power in the lamp body. Regions of the lamp body may remain uncoated to allow power to be transferred to or from the lamp body. For example, the bulb 104 may be positioned adjacent to an uncoated portion of the lamp body to receive radio frequency power from the lamp body. A high breakdown material, such as a layer of glass frit, may be coated on the outside of the electrically conductive coating 108 to prevent arcing, including the edges of the conductive material that are spaced a few millimeters from one another by surfaces 114 of the lamp body 102.

In the example embodiment of FIG. 1A, an opening 110 extends through a thin region 112 of the lamp body 102. The surfaces 114 of the lamp body 102 in the opening 110 are uncoated and at least a portion of the bulb 104 may be positioned in the opening 110 to receive power from the lamp body 102. In example embodiments, the thickness H2 of the thin region 112 may range from 1 mm to 10 mm or any range subsumed therein and may be less than the outside length and/or interior length of the bulb. One or both ends of the bulb 104 may protrude from the opening 110 and extend beyond the electrically conductive coating 108 on the outer surface of the lamp body. This helps avoid damage to the ends of the bulbs from the high intensity plasma formed adjacent to the region where power is coupled from the lamp body. In other embodiments, all or a portion of the bulb may be positioned in a cavity extending from an opening on the outer surface of the lamp body and terminating in the lamp body. In other embodiments, the bulb may be positioned adjacent to an uncoated outer surface of the lamp body or in a shallow recess formed on the outer surface of the waveguide body. In some example embodiments, the bulb may be positioned at or near an electric field maxima for the resonant mode excited in the lamp body.

A layer of material 116 may be placed between the bulb 104 and the dielectric material of lamp body 102. In example embodiments, the layer of material 116 may have a lower thermal conductivity than the lamp body 102 and may be used to optimize thermal conductivity between the bulb 104 and the lamp body 102. In an example embodiment, the layer 116 may have a thermal conductivity in the range of about 0.5 to 10 watts/meter-Kelvin (W/mK) or any range subsumed therein. For example, alumina powder with 55% packing density (45% fractional porosity) and thermal conductivity in a range of about 1 to 2 watts/meter-Kelvin (W/mK) may be used. In some embodiments, a centrifuge may be used to pack the alumina powder with high density. In an example embodiment, a layer of alumina powder is used with a thickness D5 within the range of about ⅛ mm to 1 mm or any range subsumed therein. Alternatively, a thin layer of a ceramic-based adhesive or an admixture of such adhesives may be used. Depending on the formulation, a wide range of thermal conductivities is available. In practice, once a layer composition is selected having a thermal conductivity close to the desired value, fine-tuning may be accomplished by altering the layer thickness. Some example embodiments may not include a separate layer of material around the bulb and may provide a direct conductive path to the lamp body. Alternatively, the bulb may be separated from the lamp body by an air-gap (or other gas filled gap) or vacuum gap.

In some example embodiments, alumina powder or other material may also be packed into a recess 118 formed below the bulb 104. In the example shown in FIG. 1A, the alumina powder in the recess 118 is outside the boundaries of the waveguide formed by the electrically conductive material 108 on the surfaces of the lamp body 102. The material in the recess 118 provides structural support, reflects light from the bulb and provides thermal conduction. One or more heat sinks may also be used around the sides and/or along the bottom surface of the lamp body to manage temperature. Thermal modeling may be used to help select a lamp configuration providing a high peak plasma temperature resulting in high brightness, while remaining below the working temperature of the bulb material. Example thermal modeling software includes the TAS software package available commercially from Harvard Thermal, Inc. of Harvard, Mass.

In an example embodiment, the probes 120 and 122 may be brass rods glued into the lamp body using silver paint. In other embodiments, a sheath or jacket of ceramic or other material may be used around the bulbs, which may change the coupling to the lamp body. In an example embodiment, a printed circuit board (pcb) may be positioned transverse to the lamp body for the drive electronics. The probes 120 and 122 may be soldered to the pcb and extend off the edge of the pcb into the lamp body (parallel to the pcb and orthogonal to the lamp body). In other embodiments, the probes may be orthogonal to the pcb or may be connected to the lamp drive circuit through SMA connectors or other connectors. In an alternative embodiment, the probes may be provided by a pcb trace and portions of the pcb board containing the trace may extend into the lamp body. Other radio frequency feeds may be used in other embodiments, such as microstrip lines or fin line antennas.

In an example embodiment, the drive probe 120 is positioned closer to the bulb in the center of the lamp body than the electrically conductive material 108 around the outer circumference of the lamp body 102. This positioning of the drive prove 120 can be used to improve coupling of power to the plasma in the bulb 104.

An amplifier 124 is used to provide radio frequency power to the drive probe 120. A high efficiency amplifier may have some unstable regions of operation. The amplifier 124 phase shift imposed by the feedback loop of the lamp circuit 106 should be configured so that the amplifier operates in stable regions even as the load condition of the lamp changes. The phase shift imposed by the feedback loop is determined by the length of the loop (including matching network 126) and any phase shift imposed by circuit elements such as a phase shifter 130. At initial startup before the noble gas in the bulb is ignited, the load appears to the amplifier as an open circuit. The load characteristics change as the noble gas ignites, the fill vaporizes and the plasma heats up to steady state operating conditions. The amplifier and feedback loop are designed so the amplifier will operate within stable regions across the load conditions that may be presented by the lamp body and plasma. The amplifier 124 may include impedance matching elements such as resistive, capacitive and inductive circuit elements in series and/or in parallel. Similar elements may be used in the matching network. In one example embodiment, the matching network is formed from a selected length of pcb trace that is included in the lamp drive circuit between the amplifier 124 and the drive probe 120. These elements are selected both for impedance matching and to provide a phase shift in the feedback loop that keeps the amplifier within stable regions of its operation. A phase shifter 130 may be used to provide additional phase shifting as needed to keep the amplifier in stable regions.

The amplifier 124 and phase shift in the feedback loop may be designed by looking at the reflection coefficient Γ which is a measure of the changing load condition over the various phases of lamp operation, particularly the transition from cold gas at start-up to hot plasma at steady state. Γ, defined with respect to a reference plane at the amplifier output, is the ratio of the “reflected” electric field Eᵢₙ heading into the amplifier, to the “outgoing” electric field Eₒᵤₜ traveling out. Being a ratio of fields, Γ is a complex number with a magnitude and phase. A useful way to depict changing conditions in a system is to use a “polar-chart” plot of Γ's behavior (termed a “load trajectory”) on the complex plane. Certain regions of the polar chart may represent unstable regions of operation for the amplifier 124. The amplifier 124 and phase shift in the feedback loop should be designed so the load trajectory does not cross an unstable region. The load trajectory can be rotated on the polar chart by changing the phase shift of the feedback loop (by using the phase shifter 130 and/or adjusting the length of the circuit loop formed by the lamp drive circuit to the extent permitted while maintaining the desired impedance matching. The load trajectory can be shifted radially by changing the magnitude (e.g., by using an attenuator).

High frequency simulation software may be used to help select the materials and shape of the lamp body and electrically conductive coating to achieve desired resonant frequencies and field intensity distribution in the lamp body. Simulations may be performed using software tools such as HFSS, available from Ansoft, Inc. of Pittsburgh, Pa., and FEMLAB, available from COMSOL, Inc. of Burlington, Mass. to determine the desired shape of the lamp body, resonant frequencies and field intensity distribution. The desired properties may then be fine-tuned empirically.

While a variety of materials, shapes and frequencies may be used, one example embodiment has a lamp body 102 designed to operate in a fundamental TM resonant mode at a frequency of about 880 MHz (although the resonant frequency changes as lamp operating conditions change as described further below). In this example, the lamp has an alumina lamp body 102 with a relative permittivity of 9.2. The lamp body 102 has a cylindrical outer surface as shown in FIG. 1B with a recess 118 formed in the bottom surface. In an alternative embodiment shown in FIG. 1C, the lamp body 102 may have a rectangular outer surface. The outer diameter D1 of the lamp body 102 in FIG. 1B is about 40.75 mm and the diameter D2 of the recess 118 is about 8 mm. The lamp body has a height H1 of about 17 mm. A narrow region 112 forms a shelf over the recess 118. The thickness H2 of the narrow region 112 is about 2 mm. As shown in FIG. 1A, in this region of the lamp body 102 the electrically conductive surfaces on the lamp body are only separated by the thin region 112 of the shelf. This results in higher capacitance in this region of the lamp body and higher electric field intensities. This shape has been found to support a lower resonant frequency than a solid cylindrical body having the same overall diameter D1 and height H1 or a solid rectangular body having the same overall width and height. For example, in some embodiments, the relative permittivity is in the range of about 9-15 or any range subsumed therein, the frequency of the RF power is less than about 1 GHz and the volume of the lamp body is in the range of about 10 cm³ to 30 cm³ or any range subsumed therein.

In this example, a hole 110 is formed in the thin region 112. The hole has a diameter of about 5.5 mm and the bulb has an outer diameter of about 5 mm. The shelf formed by the thin region 112 extends radially from the edge of the hole 110 by a distance D3 of about 1.25 mm. Alumina powder is packed between the bulb and the lamp body and forms a layer having a thickness D5 of about ¼ mm. The bulb 104 has an outer length of about 15 mm and an interior length of about 9 mm. The interior diameter at the center is about 2.2 mm and the side walls have a thickness of about 1.4 mm. The bulb protrudes from the front surface of the lamp body by about 4.7 mm. The bulb has a high pressure fill of Argon, Kr₈₅, Mercury and Indium Bromide as described above. At pressures above 400 Torr, a sparker or other ignition aid may be used for initial ignition. Aging of the bulb may facilitate fill breakdown, and the fill may ignite without a separate ignition aid after burn-in of about 72 hours.

In this example, the drive probe 120 is about 15 mm long with a diameter of about 2 mm. The drive probe 120 is about 7 mm from the central axis of the lamp body and a distance D4 of about 3 mm from the electrically conductive material 108 on the inside surface of recess 118. The relatively short distance from the drive probe 120 to the bulb 104 enhances coupling of power. The feedback probe 122 is a distance D6 of about 11 mm from the electrically conductive material 108. In one example, a 15 mm hole is drilled for the feedback probe 122 to allow the length and coupling to be adjusted. The unused portion of the hole may be filled with PTFE (Teflon) or another material. In this example, the feedback probe 122 has a length of about 3 mm and a diameter of about 2 mm. In another embodiment where the length of the hole matches the length of the feedback probe 122, the length of the feedback probe 122 is about 1.5 mm.

In this example, the bulb is positioned adjacent to narrow region 112 where the electric field of the radio frequency power in the lamp body is at a maximum. In this example, the drive probe 120 and feedback probe 122 are not positioned at a maxima or minima of the electric field of the radio frequency power in the lamp body. In example embodiments, the position of the probes may be selected for desired power coupling and impedance matching.

In this example, the lamp drive circuit 106 includes an attenuator 128, phase shifter 130, amplifier 124, matching network 126 and control electronics 132 such as a microprocessor or microcontroller that controls the drive circuit. A sensor 134 detects the intensity of light emitted by the bulb 104 and provides this information to the control electronics 132 to control the drive circuit 132. In an alternative embodiment, an RF power sensor 136 may be used to determine forward, reflected or net power to be used by the control electronics to control the drive circuit.

The above dimensions, shape, materials and operating parameters are examples only and other embodiments may use different dimensions, shape, materials and operating parameters.

1. An electrodeless plasma lamp comprising:
a lamp body comprising a dielectric material having a relative permittivity greater than 2;
a bulb adjacent to the lamp body, the bulb containing a fill that forms a plasma when RF power is coupled to the fill from the lamp body;
a radio frequency (RF) feed coupled to the lamp body; and
a radio RF power source for coupling power into the lamp body through the RF feed and wherein frequency of the RF power source is adjusted in response to changing conditions of the fill during startup.

2. An electrodeless plasma lamp comprising:
a lamp body comprising a dielectric material having a relative permittivity greater than 2;
a bulb adjacent to the lamp body, the bulb containing a fill that forms a plasma when RF power is coupled to the fill from the lamp body;
a radio frequency (RF) feed coupled to the lamp body;
a radio RF power source for coupling power into the lamp body through the RF feed; and
a phase shifter configured to adjust a phase of the power provided by the RF power source between ignition and steady state operation of the plasma lamp.

3. The plasma lamp of claim 2, wherein the RF power source sequentially adjusts the drive power and the phase shift to regulate current consumption to desired startup and operational levels.

4. The plasma lamp of claim 2, further comprising a sensor to detect an operating condition of the plasma lamp, wherein a phase shift is automatically triggered after the fill in the bulb is vaporized.
